(19) United States
(12) Patent Application Publication
(10) Pub. No.: US 2007/0251787 A1
(43) Pub. Date: Nov. 1, 2007

(54) Conductive shoe for a bumper car

(76) Inventor: John J. Dean, Springfield, OR (US)

Correspondence Address: James D. Givnan, Jr., 8175 S. W. Ernst Road, Portland, OR, 97225, US

(21) Appl. No.: 11/412,242

(22) Filed: Apr. 27, 2006

(51) Int. Cl. B60L 5/38

(52) U.S. Cl. 191/49

(57) ABSTRACT

A shoe is yieldably carried by flexible members for contact with conductive floor surfaces. Metal bristles of the shoe are retained in bundled shape in an inverted cup attached to the flexible members with the bristle ends for sliding contact with the floor surfaces. An arbor on the cup is in circuit with the drive system of a vehicle.

### BACKGROUND OF THE INVENTION

The present invention is embodied within an electrical shoe for sliding contact with electrically charged, floor-mounted plates to provide current to an electric motor driving a vehicle termed a bumper car, of an amusement ride.

Such amusement rides are commonly found in various locations including amusement parks, shopping malls, fairs, etc., and include a number of electrically powered miniature cars which collide with one another in a harmless manner.

The operation of such cars generates a degree of noise rendering the ride objectionable in certain areas, such as shopping malls where the ride would be adjacent business establishments catering to the public. Apparently a component of the noise is due to a solid block type pickup on each car sliding over the series of electrically charged plates. When the amusement ride is in operation anywhere from six or more vehicles may be traversing the floor surface at a time, producing an objectionable level of noise. Such a noise level has limited the operation of such amusement rides in those areas near commercial establishments.

One such bumper car amusement ride vehicle is disclosed in U.S. Pat. No. 4,324,301 incorporated herein by reference. Each vehicle shown carries multiple, spaced apart conductive blocks contributing to a substantial noise level.

### SUMMARY OF THE PRESENT INVENTION

The present invention concerns a conductive pick-up or shoe for an electrically powered vehicle which significantly reduces the noise level, ordinarily generated during vehicle operation.

The present shoe utilizes a multitude of bundled, metal bristles tightly confined within an inverted, cup shaped receptacle. Bristle ends are disposed for contact with the charged metal strip of an amusement ride floor structure. Sliding contact of the bristle ends with the floor generates far less decibels than the previously used solid block shoes.

A conductive shoe may be of the construction heretofore used in the field of cleaning brushes for use on various surfaces for removal of paint, rust, scale, etc. Such use does not incur use as an electrical conductor.

The present shoe is carried in a yieldable manner on a vehicle chassis to promote brush life and inhibit operating noise.

### BRIEF DESCRIPTION OF THE DRAWINGS

In the accompanying drawings:

FIG. 1 is a fragmentary sectional view of a prior art solid shoe in place on a vehicle chassis;

FIG. 2 is a view similar to FIG. 1 but illustrating the subject of the present invention;

FIG. 3 is an elevational view of the present shoe and associated components for vehicle attachment.

### DETAILED DESCRIPTION OF THE PREFERRED EMBODIMENTS

With continuing attention to the drawings wherein reference numerals indicate parts hereinafter similarly identified, the reference numeral 1 indicates the frame or chassis of a vehicle such as one electrically powered, as for example, a bumper car.

A plate 2 of dielectric material is mounted as by fasteners 3 to chassis 1.

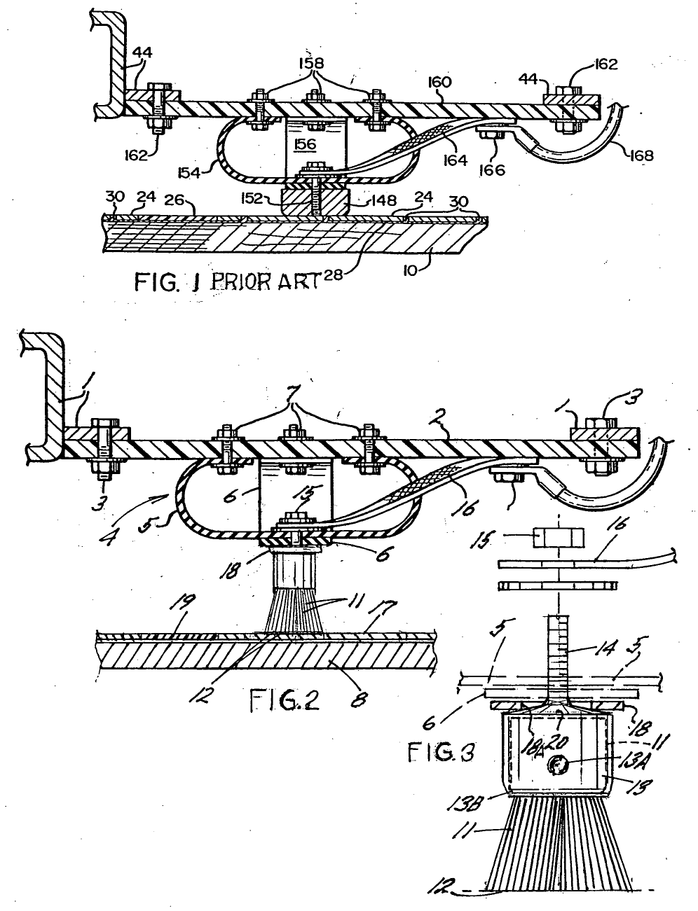

A shoe support assembly at 4 on the plate 2 utilizes flexible segments 5 and 6 of dielectric material and secured as by fasteners at 7 to plate 2. The segments at their ends 5 and 6 can flex to accommodate variances in distance between a floor 8 and the plate 2. The support assembly is very similar to that shown in FIG. 1.

Carried in a yieldable manner by flexible segments 5 and 6 is the present conductive shoe at 10. A bundle of wire bristles at 11 have co-extensive ends 12 for floor contact with the balance of the bristles being tightly confined in an inverted metal cup 13. Cup 13 may be crimped as at 13A for bristle securement. Securement of the bristles is enhanced by imparting a crimping force to opposite areas of the cup. The cup lower rim may be swaged as at 13B for bristle retention purposes. An arbor at 14 is threaded for reception of a nut 15 securing a conductive strap 16 and washer on the arbor to supply a current flow to the vehicle electrical drive system. A washer at 18 has an over sized opening 18A to cooperate with a domed cap end 20 to retain the arbor and cup in place on the flexible non-conductive segments 5 and 6.

A suitable brush is that brush manufactured by the Weiler Corporation having bristles of stainless steel and having a manufacturer's reorder number of 10021 with a threaded arbor.

The above noted U.S. Pat. No. 4,324,301, incorporated herein by reference, discloses floor structure for a bumper car ride operation with conductive plate 17 with non-conductive strips 19 therebetween. A bumper car equipped with the present invention will, at all times during operation, have certain of its multiple shoes completing a circuit including electrical components of the bumper car and conductive plates 17, the latter spaced apart by non-conductive strips 19. U.S. Pat. No. 6,581,350, incorporated herein by reference, discloses floor construction for a bumper car amusement ride.

While I have shown but one embodiment of the invention, it will be apparent to those skilled in the art that the invention may be embodied still otherwise without departing from the spirit and scope of the claimed invention.

Having thus described the invention, what is desired to be secured by a Letters Patent is:

1. A shoe for a vehicle for travel over an electrically charged floor having a series of electrically charged plates traversed by a vehicle constituting an amusement ride, said contact including,
a mounting assembly for installation on the vehicle, and including flexible members,
a multitude of metal bristles having ends in endwise sliding contact with a series of floor mounted electrically charged plates,
a retainer containing the bristles in a bundle and including fastener means coupling the retainer to said mounting assembly.

2. The shoe claimed in claim 1 wherein said retainer is of inverted cup shape.

3. The she claimed in claim 2 wherein said fastener means includes a threaded arbor.

4. The shoe claimed in claim 1 wherein said retainer is of inverted cup shape swaged to enhance bristle retention.

5. The shoe claimed in claim 1 wherein said retainer is of inverted cup shape with crimped areas for purposes of bristle retention.

6. In combination,
a vehicle having an electric drive system,
a floor having conductive plates,
a shoe carried by said vehicle for travel across said plates and in circuit with said electric drive, the shoe including a multitude of metal bristles in a bundle and having coplanar ends for contact with the plates during vehicle travel, an inverted cup confining said bristles in a bundle, a coupling on said inverted cup in circuit with the electric drive system.
